(19) United States
(12) Patent Application Publication
(10) Pub. No.: US 2003/0130924 A1
(43) Pub. Date: Jul. 10, 2003

(54) Real estate information search and retrieval method

(76) Inventors: Christopher Hugh Muldrow, Warrenton, VA (US); Willard Lewis Blevins JR., Spotsylvania, VA (US); Allen John Schmidt SR., Fredericksburg, VA (US)

Correspondence Address: LARSON & TAYLOR, PLC, 1199 NORTH FAIRFAX STREET, SUITE 900, ALEXANDRIA, VA, 22314, US

(21) Appl. No.: 10/038,684

(22) Filed: Jan. 8, 2002

(51) Int. Cl. G06F 17/60

(52) U.S. Cl. 705/37

(57) ABSTRACT

A method for remotely accessing a real estate listing database using a wireless phone or other wireless communication devices is provided in which a user first inputs the street number of a property which the user wishes to get information. The street number is then used to query an existing multiple listing service database. Subsequently, the user is provided with a list of street names on which properties with that particular street number are for sale. The user then selects a particular address in which the user is interested. After the selection is made, the user is provided with information pertaining to the selected property such as a description of the property for sale.

### BACKGROUND OF THE INVENTION

1. Field of the Invention

The present invention relates to a real estate information search and retrieval method, and, in particular, the present invention relates to a method for data acquisition from a real estate database in which an interested party can acquire real estate information from the real estate database using a wireless communication device.

2. Background of the Invention

Real estate properties for sale are typically compiled in a multiple listing service (MLS) database. Various method and systems are available for storing, retrieving, displaying, printing and manipulating data stored in the MLS database. One conventional method for acquiring information about a specific property for sale includes searching the MLS database by the complete street address of the property for sale or by an MLS number corresponding to the property. The user is subsequently provided with information pertaining to the property for sale such as the number of bedrooms, bathrooms, square footage, the list price and dimensions of the property.

Numerous interfaces have been employed for use in accessing the information contained within MLS databases. These include access implementation through stand-alone personal computer applications as well as HTML based systems for access via the Internet.

U.S. Pat. No. 5,852,510 to Sotiroff et al. discloses a property retrieval system with a graphical user interface for providing a user with information regarding housing within a geographic area. A user selects an ever narrow graphical area using a web browser via the Internet. Next, the user can graphically select individual properties within the specific region from an information database and view specific information pertaining to each property such as size, number of bedrooms, number of bathrooms and cost. In addition, the user can query the information database by inputting search criteria such as the number of bedrooms, bathrooms and cost so as to limit the displayed housing to just those which meet the search criteria.

U.S. Pat. No. 6,112,153 to Schaaf et al. discloses a navigation (mapping) method and system for identifying and displaying a list of all addresses which contain address components which satisfy a search criteria comprising a “state name,” “street base name,” and “house number.” The “street base name” is the street name without any prefix such as “E,” “Northwest,” or suffix such as “Ave.,” “Rd.,” “St.,” “Lane.” A listing of possible addresses is subsequently presented to the user who is then prompted to choose an address from the list provided.

U.S. Pat. No. 5,794,216 to Brown discloses a real estate database comprising textual and photographic information for each house stored as discrete records in the database. The house information includes binary picture information, hot spot coordinates to be displayed for each hot spot, and textual information to be displayed to the user corresponding to each hot spot. A viewing program allows the user to query the database on any one or more fields which include number, street, price, city and zip code. A list of all properties which meet the search criteria is then displayed.

### BRIEF SUMMARY OF THE INVENTION

Generally speaking, the present invention provides a real estate database searching method using a wireless communication device for receiving information about a property for sale. The wireless communication device preferably includes a wireless telephone or a portable computer such as a hand-held computer.

According to an important feature of the present invention, a real estate database is queried using the street number of the property for sale as a sole query term and then automatically return a list of street names within a predetermined geographic area which have houses for sale having the street number. Information pertaining to the house for sale is then provided after selecting the street name corresponding to the property for sale.

An additional feature of the present invention, in one form thereof, concerns providing an interested party with an option to contact a listing broker associated with the property after the interested party has entered the street address and selected the street name associated with the property for sale.

In accordance with the above features, the present invention relates to a method for providing real estate information to an interested party by first receiving a street number as a real estate information request from the interested party using a wireless communication device and querying a database of properties for sale within a predetermined area using the street number as a sole query term. Subsequently, a list of street names having properties with the street number for sale within a predetermined area is generated automatically. The list of street names is sent to the wireless communication device and the interested party selects the street name using the wireless communication device. The interested party is then provided with real estate information pertaining to the property for sale having the street number and selected street name via the wireless communication device. In a further embodiment, the interested party is provided an option to communicate with a listing broker associated with the property via the wireless communication device.

In accordance with another aspect of the present invention, a method is provided for retrieving real estate information by an interested party which includes initiating a query request by an interested party via inputting a street number using a wireless communication device. A list of street names having properties with the street number for sale within a predetermined area is received by the interested party in which the listing is generated automatically by querying a database of properties for sale within a predetermined area using the street number as a sole query term. Next, the interested party selects a street name using the wireless communication device and then the interested party is provided with real estate information pertaining to the property having the street number and selected street name. In further alternate embodiments, the listing of street names and real estate information is received through the wireless communication device in a visibly perceivable form or an audibly perceivable form. The wireless communication device may comprise a telephone or a hand-held computer.

One advantage of the present invention is the ease by which an interested party can acquiring real estate information using the street number to query a real estate database. The interested party can use easily use a standard telephone or a wireless communication device such as a handheld computer, as an input device to enter the street number. Subsequently, the interested party can use the telephone or wireless communication device to select the street name of the property of interest from a list of street names automatically generated from querying a MLS database using the street number as the query term. This makes for an extremely easy, user friendly approach for accessing the desired information.

An additional advantage of using the street number as an initial query term to query a MLS database is that the interested party does not have to know the complete address including the exact street name, county and city in order to acquire desired real information. Although an interested party, when familiar with a particular neighborhood may know the complete address, one simply riding through, or otherwise unfamiliar with, the neighborhood may not necessarily know the complete address. The present invention allows an interested party to acquire real estate information by merely knowing the property number. Subsequently, the interested party can choose the specific property of interest from a list of properties which have the street number. Thus, the interested party does not need to know the complete address in order to be provided with the relevant real estate information pertaining to the desired property.

Further features and advantages of the present invention will be set forth in, or apparent from, the detailed description of preferred embodiments thereof which follows.

### BRIEF DESCRIPTION OF THE DRAWING

The invention will now be described in detail with respect to preferred embodiments with reference to the accompanying drawings, wherein:

FIG. 1 is a flow chart of a method for accessing and retrieving real estate information contained in a MLS database according to the present invention;

FIG. 2 is a flow chart of a method of compiling information which satisfies the search request in accordance with the present invention; and

FIG. 3 is a schematic diagram of a request structure of the real estate information retrieval method in accordance with the present invention.

### DETAILED DESCRIPTION OF THE INVENTION

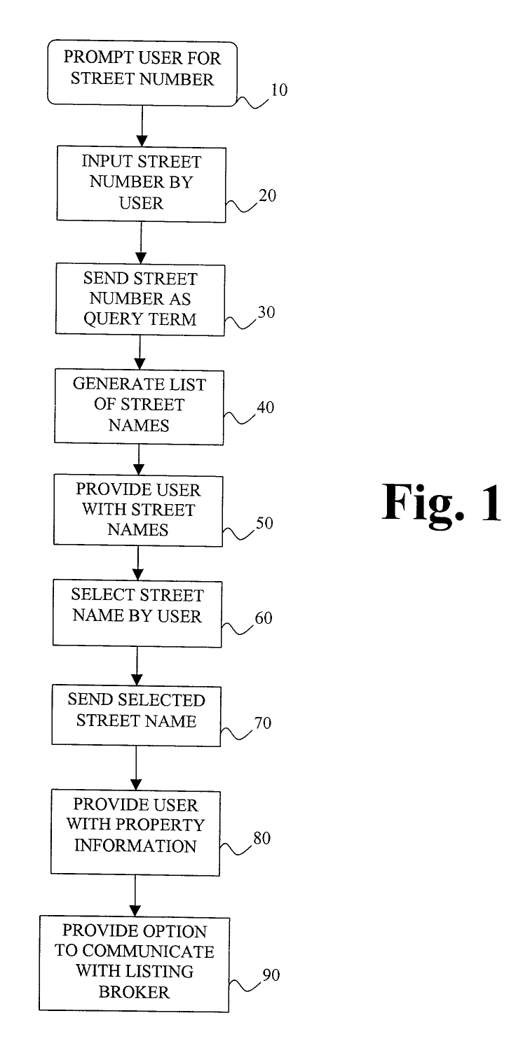

A preferred embodiment of the method of the invention for acquiring real estate information from a MLS database will now be described with reference to the flow chart of FIG. 1. A user of the system, i.e., an interested party interested in acquiring real estate information, upon seeing a property (e.g., when driving through the neighborhood in which the property is located) or upon otherwise learning of the property is first prompted to, or otherwise elects to, input the street number of a property, as indicated by block 10. The user uses a wireless communication device to enter the street number as indicated by block 20. Depending on the type of wireless communication device used, the user may employ any of a number of different input methods for entering the street number. If the wireless communication device is a wireless telephone, the user may enter the street number using the telephone keypad or the user may speak the street number. Alternatively, if the wireless communication device is a hand-held computer, the user may enter the street number using a keyboard, touch screen, stylus, microphone or other suitable implement or method for entering data in a hand-held computer.

The street number is then sent as a wireless request from the wireless device to a server containing the database, as indicated by block 30. The database is queried using the street number as the sole query request term.

As indicated by block 40, in response to the query, a list is generated automatically of street names having properties with the street number for sale within a predetermined area. The list of street names includes all properties contained within the database or a predefined geographic area which satisfy the street number query, i.e., all street addresses, street names and numbers, which have property for sale with the street number.

Next, the list of street names is sent wirelessly to the user, as indicated by block 50. The list of street names is provided to the user in any of a number of user perceivable forms. For example, the user can be provided with an audible (oral) listing of street names with corresponding numbers from which a user may select a street name by choosing the corresponding number, using a wireless hand-held device such as a telephone. Alternatively, if the user is using a wireless hand-held device equipped with a graphic or text display, the user can be provided with a list of street names in graphic or text form.

After being provided with this listing, the user selects the street name corresponding to the property about which the user wishes to obtain information, as indicated by block 60. As with inputting the street number, the street name may be selected using any appropriate method consistent with the wireless communication device being used. For example, if the wireless communication device is a telephone, the street name can be selected via an oral or spoken input by the user. In an alternative embodiment, the system can be implemented such that the user can simply select a number which corresponds with the desired street name. If the wireless communication device is a handheld computer, the system can be implemented such that the user can make a street name selection by choosing, e.g., “clicking” on, the desired street name.

The user selected street name is then sent wirelessly to the server containing the database, as indicated by block 70. In response, the user is provided with property information contained in the database which is received by the wireless communication device, as indicated by block 80. The property information may include the size of the lot, the number of bedrooms, bathrooms, square footage, or other information pertaining to the property for sale.

The property information can be provided to the wireless communication device for use by the user in any number of applicable forms, depending on the wireless communication device of the user. Such forms include providing the information orally and visually in the form of graphics or text provided for display on an appropriately equipped wireless communication device.

Preferably, the user is also provided with the option to communicate with the listing broker of the property, as indicated by block 90. Optimally, if the user wishes to communicate with the listing broker, a corresponding selection by the user results in the wireless communication device placing a telephone call directly to the listing broker. Alternatively, the user may send an e-mail message to the listing broker.

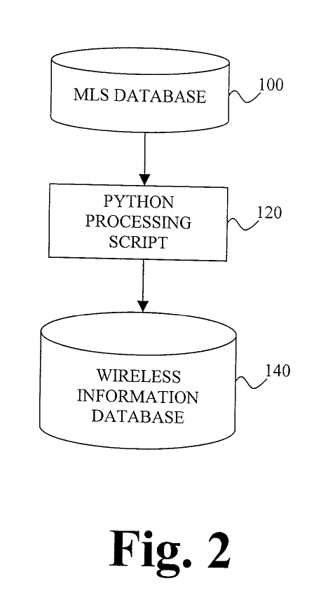

The present real estate information retrieval method is configurable for implementation with existing MLS databases. In order to use the information contained within the databases, property information first must be extracted. One method by which the present real estate information retrieval method extracts particular property information to be provided to the user will now be described with reference to FIG. 2.

Turning to FIG. 2, as described above, the MLS database 100 is stored on servers at a multiple listing service. A processing script, such as a Python processing script 120, is used to perform a remote procedure call to the multiple listing service server. The Python processing script 120 accepts a delimited text file of the entire MLS database 100. The Python processing script 120 then parses the data of the MLS database 100 in order to retrieve individual records for each property, e.g., house, for sale.

The Python processing script 120 is configurable so that specific information can be retrieved for each property listed and then stored in a wireless information database 140. After the data of the MLS database 100 has been parsed, a Python SQL connection, accessible via the Internet, inserts the parsed data into the wireless information database 140.

Advantageously, for accommodating a variety of alternately configured wireless communication devices, data contained in the wireless information database 140 is adjustable by an operator implementing the real estate information retrieval method. This allows the operator to limit the size of the wireless information database 140 so that the wireless information database 140 will not include unnecessary data. In addition, the operator can limit the data to which a user may access.

Conventional database tools known in the art can be used to implement the access and parsing of data from existing MLS databases. Such tools include Microsoft Access and My SQL Database. Further, the present method is easily reconfigurable for use with any database that uses standard ANSI Structured Query Language (SQL).

Preferable, the parsed data present in the wireless information database 140 is available in formats suitable for wireless access. For example, if the user is using a wireless communication device which comprises an Internet device, the data is provided in a format suitable for delivery through a HTTP server. Two applicable data format structures for delivering data to a wireless data device include Hand Device Markup Language (HDML) and Wireless Markup Language (WML).

Alternatively, if the wireless device is a telephone, an intermediate voice translator which converts text into spoken language is used to provide the property information to the user.

A Zope web application development environment (a Python-based open-source system that provides a HTTP server as well as dynamic delivery of HTTP-based content) provides marked-up headers and footers for pages in both HDML and WML formats. When a user uses a wireless Internet device, as the wireless communication device, an HTTP request is made to the Zope server. Subsequently, the HTTP request is checked for the “http-accept” value which communicates whether the wireless Internet device will display WML or HDML. Once the specific device language is identified, the application sends the users wireless Internet device a http-redirect response to an appropriate “home page” for the user's device.

A script for implementing identification and configuration for a specific wireless Internet device is provided below.

Code for redirect page

<dtml-if expr=“_.string.find(_.string.lower(REQUEST[‘HTTP_ACCEPT’]),‘/x-hdml’)
>0”>
Content-Type:text/x-hdml
<HDML VERSION=3.0 MARKABLE=“TRUE” TTL=“0”><NODISPLAY
NAME=nd><ACTION TYPE=ACCEPT TASK=GO
DEST=“http://fred411.com/wirelessindex,hdml”></NODISPLAY></HDML>
<dtml-elif
expr=“_.string.find(_.string.lower(REQUEST[‘HTTP_ACCEPT’]),‘/vnd.wap’)>0”>
<?xml version=“1.0”?>
<!DOCTYPE wml PUBLIC “-//WAPFORUM//DTD WML 1.1//EN”
“http://www.wapforum.org/DTD/wml_1.1.xml”>
<wml>
<card title=“Fred411”>
<onevent type=“onenterforward”>
<go href=“http://fred411.com/i.wml”/>
</oneevent>
</card>
</wml>
<dtml-call “RESPONSE.setHeader(‘Content-Type’, ‘text/vnd.wap.wml’)”>
<dtml-else>
<html>
<meta http-equiv=“refresh”
content=“0;URL=http://fredericksburg.com/news/palm”>
</html>
</dtml-if>

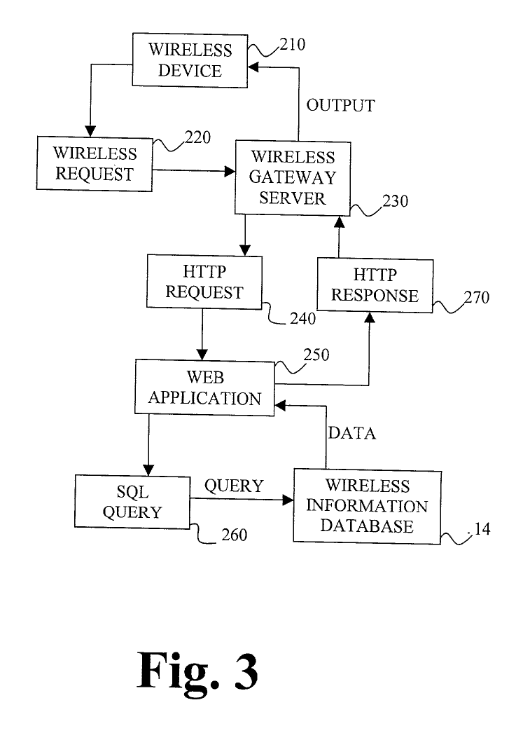

A request structure for the real estate information retrieval method is illustrated schematically in FIG. 3. The request structure is used for entering a street number and selected a street name.

Turning to FIG. 3, a user initiates a request to be provided with real estate information by inputting a street number using a wireless device 210. The wireless request 220, viz., the street number, is then transmitted from the wireless device 210 to a wireless gateway server 230.

An HTTP request 240 is then generated and sent to a web application 250. The web application 250 generates a SQL query 260 which queries the wireless information database 14 for any records that contain a “street number” field matching the entered street number.

Returning from the wireless information database 14 is DATA containing a list of specific street names which are sent back to the web application 250.

The web application then automatically returns the user a list of specific street names by providing a HTTP response 270 that is sent through the wireless gateway server 230. Subsequently, the list of street names is provided to the wireless communication device 210 in the form of a visually perceivable web page.

The same request structure of FIG. 3 is used when the user selects a desired street name. Selecting a desired street name by the user sends a wireless request 220 through the wireless gateway 230 which produces an HTTP street name request to the web application 250 which performs a SQL query of the wireless information database 14. The QUERY then returns DATA in the form of individual information fields such as the price of the property, square footage, number of rooms, etcetera.

As described above, the information provided to the user is configurable by the operator implementing the real estate information retrieval present method. Thus, the operator may choose to disallow one or more fields such as price or listing agent.

DATA return from the wireless information database 14 may include a phone number of the listing agent or realtor listing the property for sale. Using a HDML or WML function, the phone number is written into a link that prompts the wireless communication device 210 to automatically dial the phone number of the agent when the user selects the “dial” link.

Script code for implementing the present real estate information retrieval method are provide by the follow examples.

Example 1: HDML search page

Content-Type: text/x-hdml
<HDML VERSION=3.0 MARKABLE=“TRUE” TTL=0>
<ACTION TYPE=SOFT1 TASK=PREV LABEL=Prev>
<ENTRY KEY=“streetnumber” FORMAT=“*N”>
<ACTION TYPE=ACCEPT TASK=GO LABEL=Search
DEST=“http://homes.fredericksburg.com/Homes/hhome2?ADDR_HOUSE=$stre
etnumber”>Search our database for information like price and number of
bedrooms in any house for sale in our area.
Just type in the street number of the house you see to get details about it.
</ENTRY>
</HDML>

Example 2: HDML search page

Content-Type: text/x-hdml
<HDML VERSION=3.0 MARKABLE=“TRUE” TTL=0>
<ACTION TYPE=SOFT1 TASK=PREV LABEL=Prev>
<CHOICE KEY=LIST_NUMB>
<ACTION TYPE=ACCEPT TASK=GO LABEL=Choose
DEST=“http://homes.fredericksburg.com/Homes/hhome3?LIST_NUMB=$LIST_N
UMB”>
<dtml-in SearchStreetMethod>
<CE VALUE=“<dtml-var LIST_NUMB>”><dtml-var ADDR_DISPLAY>
<dtml-call “REQUEST.set(‘foundResults’, ‘1’)”>
</dtml-in>
<dtml-if foundResults>
<dtml-else>
Sorry, no homes found at that street number.</dtml-if>
</CHOICE>
</HDML>

Example 3: HDML search page

Content-Type: text/x-hdml
<HDML VERSlON=3.0 MARKABLE=“TRUE”>
<ACTION TYPE=SOFT1 TASK=PREV LABEL=Prev>
<DISPLAY>
<dtml-in SearchStreetDetailMethod>
<br><dtml-var ADDR_DISPLAY html_quote>
<br>
MRIS Number: <dtml-var LIST_NUMB html_quote>
<br>Price: <dtml-var list_price html_quote>
<br>Bedrooms: <dtml-var BEDS_TOTAL html_quote>
<br>Full baths: <dtml-var BATH_FULL_NUM html_quote>
<br>Half baths: <dtml-var BATH_HALF_NUM html_quote>
<br>Square footage: <dtml-var TOTAL_AREA html_quote>
<br>Listing agent: <dtml-var LIST_BROKER_NAME html_quote>
<br><A TASK=CALL LABEL=Call NUMBER=<dtml-var LIST_REP_PHONE
html_quote>>Select this line to call about this house right now! Phone: <dtml-var
LIST_REP_PHONE html_quote></A>
</dtml-in>
</DISPLAY>
</HDML>

Example 4: SQL query for addresses

select ADDR_DISPLAY, LIST_NUMB
from Homes
where ADDR_HOUSE = <dtml-sqlvar ADDR_HOUSE type=string>

Example 5: SQL query for home information

select * from Homes where LIST_NUMB = <dtmI-sqlvar LIST_NUMB
type=string>

As will be apparent to one of ordinary skill in the art, the present method, which has been described as being implemented in a Zope environment, can be adapted to deploy the real estate information retrieval method for use in alternative environments. For example, a Perl DBI module can be used in conjunction with an Internet Common Gateway Interface database, Python database connectivity tool can be used in conjunction with CGI, Active Server Pages can be used in conjunction with a Microsoft-based database, and Java Server Pages can be used in conjunction with various ODBC-compliant databases.

It will be understood from the foregoing that the present real estate information retrieval method offers important features and advantages previously unavailable in the art. For example, the present method provides voice access to a multiple listing service database of properties for sale. A user can be provided with information pertaining to a property for sale using a conventional wireless telephone such as a cellular or other wireless device. An additional feature of the present invention is that wireless access is provided to a multiple listing service database using a wireless Internet device so that information is provided in a form specifically adapted for use on the hand-held Internet device.

Although the invention has been described above in relation to preferred embodiments thereof, it will be understood by those skilled in the art that variations and modifications can be effected in these preferred embodiments without departing from the scope and spirit of the invention.

What is claimed is:

1. A method for providing real estate information to an interested party, said method comprising the steps of:
receiving a street number as a real estate information request from the interested party using a wireless communication device;
querying a database of properties for sale within a predetermined area using the street number a sole query term and automatically generating a list of street names having properties with the street number for sale within the predetermined area;
sending the list of street names to the interested party using the wireless communication device;
receiving a selected street name from the interested party using the wireless communication device; and
providing real estate information pertaining to a property for sale having the street number and selected street name to the interested party using the wireless communication device.

2. The method of claim 1, further comprising the step of providing the interested party with an option to communicate with a listing broker associated with the property using the wireless communication device.

3. The method of claim 2, wherein said step of providing the interested party with an option to communicate with the listing broker comprises facilitating a telephone connection between the interested party and the listing broker.

4. The method of claim 2, wherein said step of providing the interested party with an option to communicate with the listing broker comprises facilitating e-mail messaging between the interested party and the listing broker.

5. The method of claim 1, wherein the real estate information is sent in a form to be visibly perceived.

6. The method of claim 1, wherein the real estate information is sent in a form to be audibly perceived.

7. The method of claim 1, wherein the wireless communication device comprises a telephone.

8. The method of claim 1, wherein the wireless communication device comprises a handheld computer.

9. A method for retrieving real estate information by an interested party, said method comprising the steps of:
initiating a query request by an interested party via inputting a street number using a wireless communication device;
receiving a list of street names having properties with the street number for sale within the predetermined area, the listing having been generated automatically by querying a database of properties for sale within a predetermined area using the street number as a sole query term;
selecting a street name by the interested party using the wireless communication device; and
receiving real estate information pertaining to a property having the street number and selected street name through the wireless communication device.

10. The method of claim 9, further comprising the steps of:
receiving an offer to contact a listing broker associated with the property, the offer being provided to the interested party via the wireless communication device; and
communicating directly with the listing broker via the wireless communication device.

11. The method of claim 9, wherein the real estate information received through the wireless communication device is perceivable by the interested party in a visible form.

12. The method of claim 9, wherein the real estate information received through the wireless communication device is perceivable by the interested party in an audible form.

13. The method of claim 9, wherein the wireless communication device comprises a telephone.

14. The method of claim 9, wherein the wireless communication device comprises a handheld computer.

15. The method of claim 9, wherein said steps of initiating a query request by inputting a street number comprises inputting the street number by the interested party as a oral input.

16. The method of claim 9, wherein said steps of selecting a street name comprises inputting the street name by the interested party as an oral input.

17. An interactive method for providing real estate information, wherein:
an interested party inputs a street number using a wireless communication device to initiate a request;
an information provider receives the request, queries a database of properties for sale within a predetermined area using the street number as a sole query term, and using said wireless communication device, sends the interested party a list of street names having properties with said street number that are for sale within the predetermined area;
the interested party then selects street name and sends the selected street name to the information provider; and
the information provider, responsive to receiving the selected street name, provides the interested party with real estate information pertaining to a property for sale having the street number and selected street name.
